(19) United States
(12) Patent Application Publication
(10) Pub. No.: US 2024/0362796 A1
(43) Pub. Date: Oct. 31, 2024

(54) IMAGE ANALYSIS TO SWITCH AUDIO DEVICES

(71) Applicant: Hewlett-Packard Development Company, L.P., Spring, TX (US)

(72) Inventors: ANN ALEJANDRO VILLEGAS, Spring, TX (US); HUI LENG LIM, Spring, TX (US); PETER SIYUAN ZHANG, Spring, TX (US); LAN WANG, Spring, TX (US); YUN DAVID TANG, Spring, TX (US); KING SUI KEI, Spring, TX (US)

(73) Assignee: Hewlett-Packard Development Company, L.P., Spring, TX (US)

(21) Appl. No.: 18/565,041

(22) PCT Filed: Jun. 18, 2021
(86) PCT No.: PCT/US2021/038090

§ 371 Date: Nov. 28, 2023

(51) Int. Cl. G06T 7/20; G06F 3/16; G06V 10/764; G06V 40/20

(52) U.S. Cl. CPC G06T 7/20; G06F 3/165; G06V 10/764; G06V 40/28

(57) ABSTRACT

An example non-transitory machine-readable medium includes instructions that, when executed by a processor, cause the processor to analyze a video captured by a computing device to detect a sequence of motion in the video, and select an audio endpoint of the computing device based on the sequence of motion.

### BACKGROUND

Audio endpoints, such as speakers, headsets, and earbuds, are used with computing devices to output digital audio signals as sound. A computing device may have multiple different audio endpoints available for selection. A computing device may use a selected audio endpoint during a videoconference or other process that uses digital imaging and sound.

### BRIEF DESCRIPTION OF THE DRAWINGS

FIG. 1 is a block diagram of an example non-transitory machine-readable medium with instructions to select an audio endpoint based on image analysis.

FIG. 2 is a flowchart of an example method of selecting an audio endpoint based on image analysis.

FIG. 3 is a block diagram of an example computing device to switch audio endpoints based on image analysis.

FIG. 4 is a flowchart of an example method of selecting an audio endpoint based on motion detection and object detection in images.

FIG. 5 is a state diagram of example states of audio endpoints as determined from changes detected by image analysis.

FIG. 6 is a block diagram of an example machine-learning system that includes location-detecting, motion-detecting, and object-detecting machine-learning models.

### DETAILED DESCRIPTION

Selecting an audio endpoint from a range of available audio endpoints may be inefficient and cumbersome to users. Often selection is provided by a list of available audio endpoints from which a user may select their preference. Finding and navigating such a list may be confusing, unintuitive, and time consuming. In addition, it is often the case that a computing device's operating system and applications offer multiple different ways to select an audio endpoint, and the precedence among the multiple different ways of making an audio endpoint selection many be unclear.

Some approaches to automating audio endpoint selection use dedicated sensors, such as a capacitive sensor, proximity sensor, accelerometer, or similar type of sensor to detect user activity that suggests a preferred audio endpoint. These approaches may require specialized hardware, such as the sensor itself, and specialized data handling, such as a dedicated driver to capture sensor data and operating system or application support to process the sensor data.

Disclosed herein are techniques to automatically switch between audio endpoints, such as a headset, earbuds, speaker, or similar audio endpoint of a computing device using image analysis.

Image analysis, such as analysis of video frames of a videoconference, is used to detect a desired audio endpoint. Machine learning may be used to detect motion and objects indicative of a desired switch of audio endpoint. The analysis may include user gesture detection and recognition of audio endpoints in the images. Two-stage detection may be used, in that a gesture may first detected before image recognition of an audio endpoint is attempted. A computing device's camera may be used to capture the images to be analyzed. As computing devices are often made with integrated cameras and image capture and processing is widely supported, a separate dedicated sensor and support is not required. In addition, the captured images used in the image analysis are often captured for another purpose, such as a videoconference, so specialized data handling and related processing may be reduced or eliminated.

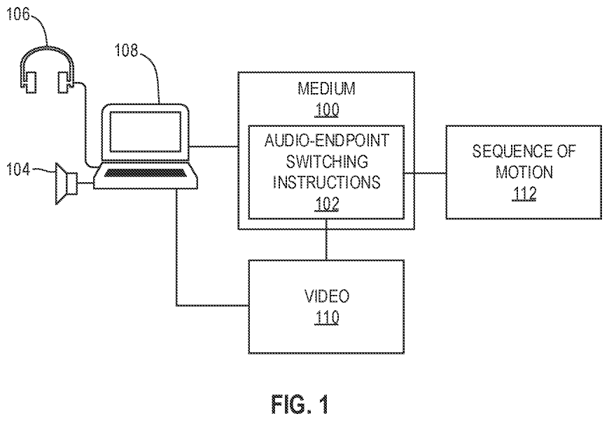

FIG. 1 shows an example non-transitory machine-readable medium 100 with audio-endpoint switching instructions 102 to select an audio endpoint 104, 106 based on image analysis. It is noted that the “non-transitory” does not encompass transitory propagating signals.

The medium 100 may include an electronic, magnetic, optical, or other physical memory or storage device that encodes the instructions 102 that implement the functionality discussed herein. The medium 100 may include non-volatile storage or memory, such as a hard disk drive (HDD), solid-state drive (SSD), read-only memory (ROM), electrically-erasable programmable read-only memory (EEPROM), or flash memory. The medium 100 may include volatile memory, such as random-access memory (RAM) to facilitate execution of the instructions 102.

The medium 100 may cooperate with a processor of a computing device 108 to execute the instructions 102. The instructions 102 may include directly executed instructions, such as a binary sequence or machine code. The instructions 102 may include interpretable code, bytecode, source code, or similar instructions that may undergo additional processing to be executed. All of such examples may be considered processor-executable instructions.

The medium 100 may be provided to the computing device 108, which may be a desktop computer, notebook computer, tablet computer, smartphone, or similar device capable of capturing video, capturing a sequence of images, participating in a videoconference, or performing a combination of such. The computing device 108 further communication an audio signal with a selected audio endpoint 104, 106.

Audio endpoints 104, 106 may provide audio output, such as voice and sound effects, to a user. Audio endpoints 104, 106 may be implemented by wearable devices, such as headsets and earbuds, and non-wearable devices, such as speakers internal to a housing of a computing device 108 and external speakers connected by a cable to a computing device 108. Audio endpoints 104, 106 may provide audio input, such as with a microphone to capture voice or other sound. In the examples discussed here, an audio endpoint 104, 106 provides a single input or output function. Discussion of audio output also applies to audio input, and vice versa. Multiple audio endpoints may be controlled separately or together. For example, a headset's loudspeaker drivers may be one audio endpoint and a microphone integrated with the headset may be another audio endpoint, and such endpoints may be controlled together or separately. In the example illustrated, the audio endpoint 106 is a wearable device, such as a headset, connected to the computing device 108 by a cable or wireless adapter (e.g., a Bluetooth™ adapter) and the audio endpoint 104 is a non-wearable device, such as an internal speaker of the computing device 108.

Audio endpoints 104, 106 may be selected and deselected. When an audio endpoint 104, 106 is selected, it operates as a destination or source of audio signals of the computing device 108. A deselected audio endpoint 104, 106 does not operate as a destination or source of audio signals. The computing device 108 may provide a list of registered and active audio endpoints 104, 106 that are capable of being selected and deselected. Deselection of a currently selected audio endpoint may be inherent to the selection of a new audio endpoint.

The audio-endpoint switching instructions 102 analyze a video 110 (or other sequence of images), which may be captured by the computing device 108, to detect a sequence of motion 112 in the video 110. The analysis may be performed with a trained machine-learning system, which may include a machine-learning model, such as Convolutional Neural Network (CNN) adapted for computer vision. The machine-learning system may be specifically configured to detect motion, such as hand motion of putting on (donning, engaging) or removing (doffing, disengaging) a wearable audio endpoint 106. Such a machine-learning system may be trained to classify user gestures in the sequence of motion 112 to detect visual indications of physical actions related to putting on or removing a headset, earbuds, or similar wearable audio device.

The audio-endpoint switching instructions 102 further select an audio endpoint 104, 106 of the computing device 108 based on the sequence of motion 112. The sequence of motion 112 may be a visual indication of the donning or doffing of the wearable audio endpoint 106. If the sequence of motion 112 is classified as a donning gesture, then the wearable audio endpoint 106 may be selected based on the donning gesture. It may be determined that the user intends to use the wearable audio endpoint 106 and, as such, the instructions 102 may automatically select this endpoint. At the same time, the instructions 102 may deselect the non-wearable audio endpoint 104, e.g., the internal speaker. Conversely, if the sequence of motion 112 is classified as a doffing gesture, then the non-wearable audio endpoint 104 may be selected based on the doffing gesture. In this case, it may be determined that the user intends to use the non-wearable audio endpoint 106 and, as such, the instructions 102 may automatically select this endpoint. At the same time, the instructions 102 may deselect the wearable audio endpoint 106.

A detected sequence of motion may be ignored if the result would not change the selected/deselected state of the audio endpoints available to the computing device 108. For example, the instructions 102 may disregard a donning gesture if the wearable audio endpoint 106 is already selected. Likewise, the instructions 102 may disregard a doffing gesture if the wearable audio endpoint is already deselected. It may be that a detected motion is spurious. As will be discussed below, confirmation of the intent of a gesture may be made by object detection of a wearable audio endpoint in the video 110 in a frame subsequent to frames used for motion detection. Presence of a wearable audio endpoint in an image may confirm a donning gesture, while absence of a wearable audio endpoint in an image may confirm a doffing gesture.

The audio-endpoint switching instructions 102 may be executed to automatically switch audio endpoints 104, 106 in real time or near real time, such as during a videoconference. Examples of real time or near real time processing rates for a videoconference range from about 20 to about 30 frames per second (FPS), such as about 25 FPS. Images captured as part of a videoconference may be analyzed at intervals during the videoconference. Intervals may be regular, periodic, or variable. Variable intervals may be timed according to a methodology suitable for videoconferencing, such as a higher frequency at the beginning of a videoconference to catch an initial audio endpoint preference and a lower frequency during a remainder of the videoconference to catch a possible, but less likely, change in preference. This may reduce or eliminate user actions in manually selecting a desired audio endpoint 104, 106 and reduce delay, inconvenience, and error associated with such.

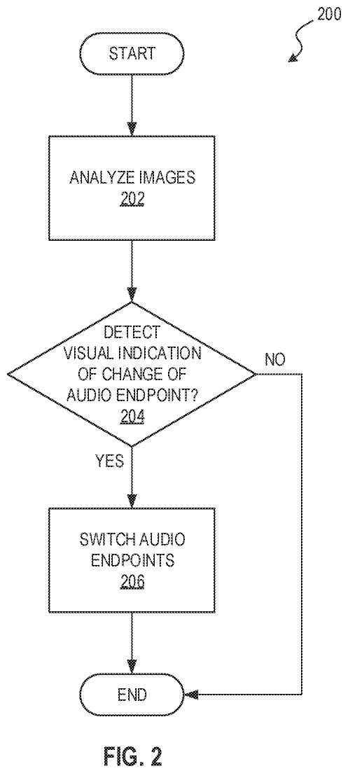

FIG. 2 shows an example method 200 of selecting an audio endpoint based on image analysis. The method 200 may be implemented by processor-executable instructions, such as instructions 102 discussed above.

At block 202, images, such as frames of video, captured by a computing device are analyzed to detect a visual indication of a sequence of motion or gesture indicative of a user of the computing device putting on or removing a wearable audio endpoint. This may include applying images to a machine-learning system that is trained to classify motion in images as indicating donning and doffing of various wearable audio devices. A machine-learning system may include a gesture-detecting machine-learning model, such as a CNN, trained to detect visual indications of engagement and disengagement gestures of wearable audio endpoints.

If the visual indication of a change of an audio endpoint is detected, at block 204, then in response, the audio endpoints of the computing device are automatically switched, at block 206. Switching audio endpoints may include deselecting a currently selected audio endpoint and selecting a wearable audio endpoint that the visual indication indicated as being put on by the user. Switching audio endpoints may include deselecting a wearable audio endpoint that the visual indication indicated as being removed by the user and selecting another audio endpoint. If the visual indication is not detected, then the audio endpoints are not switched.

Blocks 202, 204, 206 may be performed in real time or near real time during a videoconference, so as to detect when a user participating in the videoconference switches audio endpoints.

The method 200 may be repeated at regular, periodic, or variable intervals, which may be configurable.

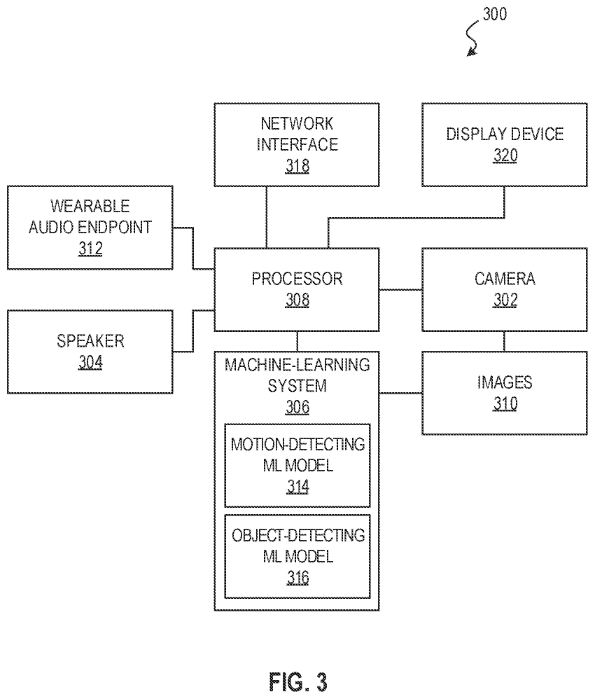

FIG. 3 shows an example computing device 300 to switch audio endpoints based on image analysis. The computing device 300 may be a desktop computer, notebook computer, tablet computer, smartphone, or similar device capable of capturing video, capturing a sequence of images, participating in a videoconference, or performing a combination of such. Features and aspects described for the computing device 108 may be used with the computing device 300 and vice versa.

The computing device 300 includes a camera 302, a speaker 304, a machine-learning system 306, and a processor 308. The computing device 300 may further include a chipset, bus, input/output circuit, memory, storage device, and similar components, which are omitted from detailed discussion for sake of clarity.

The camera 302 may include an image sensor, such as a complementary metal-oxide-semiconductor (CMOS) device, capable of capturing digital images 310. The camera 302 may be external to the computing device 300 and connected to the computing device via a cable or a wireless adaptor. The camera 302 may be internal into the computing device 300, such as an integrated webcam or smartphone camera. The camera 302 may capture a sequence of images 310 as digital video.

The speaker 304 is an audio endpoint that may include a loudspeaker, such as a diaphragm speaker or piezoelectric speaker, positioned and driven to output sound to a volume around the computing device 300. The speaker 304 may be an internal speaker that is integrated into the housing of the computing device 300 or may be an external speaker that is connected to the computing device 300 by a cable or wireless adaptor.

The machine-learning system 306 may include processor-executed instructions and a related machine-learning model in the form of layers of coefficients or similar data structure. The machine-learning system 306 may be contained on a non-transitory machine-readable medium, such as volatile memory, non-volatile memory or storage, or a combination of such.

The processor 308 may include a central processing unit (CPU), a microcontroller, a microprocessor, a field-programmable gate array (FPGA), an application-specific integrated circuit (ASIC), or a similar device capable of executing instructions. The processor 308 may cooperate with a non-transitory machine-readable medium containing the machine-learning system 306.

The processor 308 is connected to the camera 302, the speaker 304, and other components of the computing device 300. The camera 302 may be connected to the processor 308 to via a chipset, bus, similar circuit, or combination of such. The speaker 304 may be connected to the processor 308 via a chipset, bus, audio adaptor, similar circuit, or combination of such. A wearable audio endpoint 312, such as a headset or earbuds, is connectable to the processor 308 via a chipset, bus, audio adaptor, similar circuit, or combination of such. The speaker 304 and wearable audio endpoint 312 may be connected to the processor 308 via the same circuit or by different circuits. Numerous examples are possible, such as the speaker 304 being connected directly to an audio adaptor that is connected to the processor 308 and the wearable audio endpoint 312 being connected via a Universal Serial Bus (USB) to the same audio adaptor or a different audio adaptor.

The processor 308 applies the machine-learning system 306 to perform image analysis on images 310 captured by the camera 302. The processor 308 may then automatically switch between the speaker 304 and the wearable audio endpoint 312 based on the image analysis.

The machine-learning system 306 may detect motion in images 310 captured by the camera 302 and may detect representations of various wearable audio endpoints 312, such as headsets and earbuds, in the images 310. Detection of motion may provide a visual indication that a wearable audio endpoint 312 is being put on or removed by a user. Detection of a representation of the wearable audio endpoint 312 may confirm that the motion relates to a wearable audio endpoint 312 and is not another type of user motion, such as a user touching their face or hair. Detection of a representation of the wearable audio endpoint 312 may also distinguish the wearable audio endpoint 312 from a hearing aid or other device that may appear similar to a wearable audio endpoint 312 but may actually be another type of device that may be unrelated to audio communications with the computing device 300.

The machine-learning system 306 may include a motion-detecting machine-learning model 314 to detect hand motion indicative of a user physically engaging or disengaging the wearable audio endpoint 312 with their ears. The motion-detecting machine-learning model 314 may include a CNN configured for computer vision. The motion-detecting machine-learning model 314 may be trained with training video segments showing users putting on and removing headsets and earbuds of various, sizes, shapes, and types using various hand and arm motions. The motion-detecting machine-learning model 314 may be applied to a sequence of video frames, so that a current frame may be compared to a previous frame to detect motion.

The motion-detecting machine-learning model 314 may be applied to images 310 of a video according to various timing intervals. Intervals may be regular, periodic, or variable. A variable interval may be selected based on the application of the machine-learning system 306. In the example of a videoconference, a variable interval may start off short (i.e., high frequency) and increase in length (i.e., low frequency) over time based on the premise that a change in audio endpoint is often done at the start of a videoconference when a user discovers that their desired endpoint is not selected. Examples of intervals include 0.5, 1, 2, 5, and 10 seconds. In some examples, during the first five minutes of a videoconference images 310 are applied to the motion-detecting machine-learning model 314 every 0.5 seconds and, thereafter, images 310 are applied to the model 314 every 5 seconds.

The images 310 applied to the motion-detecting machine-learning model 314 may be sample frames of a video, so that fewer than all images of a sequence of video are applied to the model 314. Images for motion detection may be down-sampled by a suitable degree to reduce processing time.

The machine-learning system 306 may further include an object-detecting machine-learning model 316 to detect representations of headsets and earbuds in the images 310. Application of images 310 to the object-detecting machine-learning model 316 may be contingent on successful detection of motion by the motion-detecting machine-learning model 314. That is, object detection may be performed in response to motion being detected, and object detection may be avoided when motion is not detected.

The object-detecting machine-learning model 316 may include a CNN useful for computer vision, such as MobileNet™ or SqueezeNet™. Multiple phases of inferencing may be performed on an image 310, such as a first phase to locate a human head or face and define a region containing same, and then a second phase to detect an earbud or headset in the region. Accordingly, the object-detecting machine-learning model 316 may include a deep neural network, such as a Residual Neural Network (ResNet) or Single Shot Detector (SSD), for initial head or face detection. Additionally or alternatively, face detection may be performed using a pretrained Haar cascades classifier. Irrespective of the specific technique used, a region determined from head or face detection is shaped and sized with reference to a range of expected relative ear locations to include relevant image data for detection of a headset or earbud.

The object-detecting machine-learning model 316 may be trained with images containing visual representations of various audio endpoint devices, such as earbuds and headsets. Down-sampling of training images may be avoided to allow for effective training to detect small earbuds, which may have a dimension of about 20 or 40 pixels in a 1280×720-pixel image.

A large amount of training images may be used to account for various designs of headsets and earbuds with different shapes, configurations, colors, and sizes. Training images may include a broad range of lighting arrangements, background environments, and people with diverse characteristics, such as face shape and size, skin tone, hair length and coverage over the headset/earbuds, age, race, gender, and so on. Training images may include various other circumstances, such as an earbud/headset positioned in/over a left ear or a right ear, a person directly facing towards the camera or facing at an angle (e.g., 10, 15, 30 degrees, etc.), and hair partially covering the ear. Negative cases may also be used, such as images as provided above but without the person wearing an earbud or headset.

Headsets may be more apparent than earbuds in images 310. However, unlike earbuds, in many images an ear is partially or fully obscured by a headset. Ear shape and profile may also be trained with a suitably large amount of training images for handling a wide range of ear appearance due to age, race, gender, and other user characteristics mentioned above. When ear is not detected in an image that should otherwise show an ear due to face or head detection, the probability that a headset is being worn increases.

Due to visual similarities, a hearing aid may be falsely detected as an earbud, and so hearing aids may be co-trained with earbuds. Hearing aids may be treated as another class of object can be trained, so as to differentiate from earbuds due to different appearance, configuration, shape, color, and so on. In order to increase the accuracy in training earbuds and hearing aids, data pre-processing may be applied to training images to mask out an ear region.

The object-detecting machine-learning model 316 may implement a multi-class network with up to four classifications: ear only, headset, earbud, and hearing aid. Further action to switch audio endpoints may be based on a representation of such a classification detected in an image.

The computing device 300 may further include a network interface 318 connected to the processor 308 to enable data communications with a like computing device 300 via a computer network. The network interface 318 may include a wired or wireless network adapter to provide communications over a local-area network (LAN), wide-area network (WAN), virtual private network (VPN), mobile/cellular network, the internet, or a combination of such to allow the computing device 300 to participate in a videoconference.

The computing device 300 may further include a display device 320, such as flat-panel liquid-crystal display (LCD) or light-emitting diode (LED) display, which may be used to facilitate a videoconference.

In an example of operation of the computing device 300, as images 310 are captured by the camera 302 in real time or near real time, the images 310 are processed by the processor 308 executing the machine-learning system 306. The processor 308 may, first, apply the motion-detecting machine-learning model 314 to perform image analysis to detect a hand motion in the images 310. If a hand motion is detected, the processor 308 may then, in response, apply the object-detecting machine learning model 316 to perform additional image analysis to detect a wearable audio endpoint 312 or absence thereof. The processor 308 may then switch between the speaker 304 and the wearable audio endpoint 312 in response to detection of the wearable audio endpoint 312 or absence thereof. If the speaker 304 is selected when the wearable audio endpoint 312 is detected in an image 310 after detection of a gesture (e.g., a donning gesture), then the processor 308 may switch from the speaker 304 to the wearable audio endpoint 312. If the wearable audio endpoint 312 is selected and the wearable audio endpoint 312 is not detected (i.e., ear only or hearing aid is detected) in an image 310 after detection of a gesture (e.g., a doffing gesture), then the processor 308 may switch from the wearable audio endpoint 312 to the speaker 304.

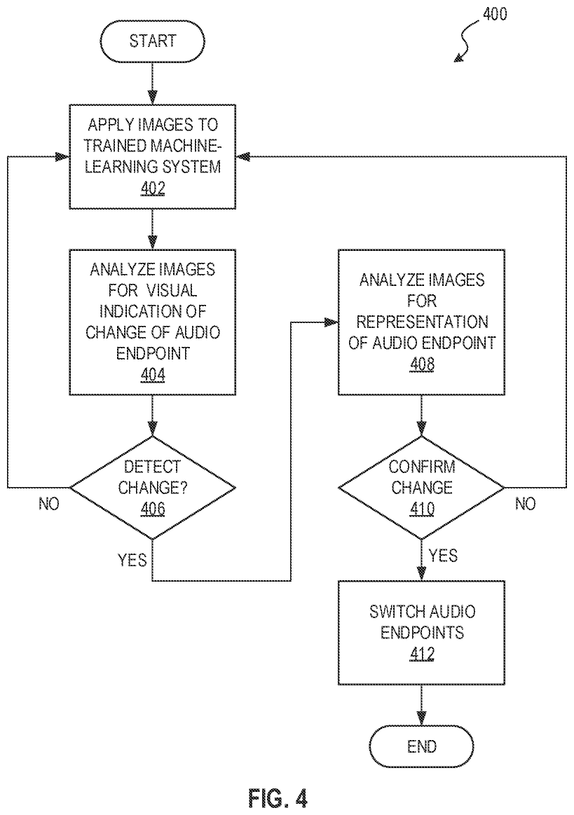

FIG. 4 shows an example method 400 of selecting an audio endpoint based on motion detection and object detection in images. The method 400 may be implemented by processor-executable instructions, a machine-learning system, machine-learning models, or a combination of such. The method 400 may be implemented by the devices 108, 300 discussed above.

At block 402, images captured by a computing device are applied to a trained machine-learning system. The images may be captured as frames of video, which may be generated as part of a videoconference or video stream.

At block 404, the trained machine-learning system detects a visual indication of a change of an audio endpoint. This may be achieved by applying images to a motion-detecting model that is trained to detect visual indications of user gestures of donning and doffing a wearable audio endpoint, such as a headset or earbuds, among a sequence of video frames. Detected gestures may be classified as donning and doffing gestures.

At block 406, if a visual indication of change in audio endpoint is detected then, in response, the trained machine-learning system is used to analyze the images for a representation of the audio endpoint, at block 408. That is, images are checked for a visual representation of a wearable audio endpoint, such as a headset or earbuds, or contrary visual representation, such as an ear or hearing aid. An object-detecting model that is trained to detect such visual representations may be applied. The representation in images subsequent to the donning or doffing gesture may indicate the presence or absence of a wearable audio endpoint. Block 408 may be considered a confirmation of the motion detection of block 404, in that a motion consistent with putting on a wearable audio device may be confirmed by the appearance of the wearable audio device in subsequent images, while a motion consistent with removing a wearable audio device may be confirmed by the absence of a wearable audio device in subsequent images.

At block 412, in response to confirmation of a change in audio endpoint based on a visual representation, at block 410, audio endpoints are automatically switched. An audio endpoint may be selected and another audio endpoint may be deselected based on detection of the representation. The detection of the presence of a wearable audio endpoint in an image may cause a switch from a non-wearable audio endpoint to the wearable audio endpoint. Conversely, the detection of the absence of a wearable audio endpoint in an image may cause a switch from the wearable audio endpoint to a non-wearable audio endpoint. Block 412 may be informed by a presently selected audio endpoint, so that redundant switching to the presently selected audio endpoint may be avoided.

If no visual indication of a change in audio endpoint is detected, at block 406, or if a detected visual indication is not confirmed a visual representation, at block 410, then the audio endpoints are not switched. The method 400 thus represents a two-stage detection of a change in audio endpoints. A first stage (blocks 404, 406) may be used to trigger a second stage (blocks 408, 410), so that detection is performed efficiently in that the second stage may be avoided depending on the result of the first stage.

The method 400 may be performed in real time or near real time during a videoconference, so as to detect when a user participating in the videoconference switches audio endpoints.

The method 400 may be repeated at regular, periodic, or variable intervals, which may be configurable.

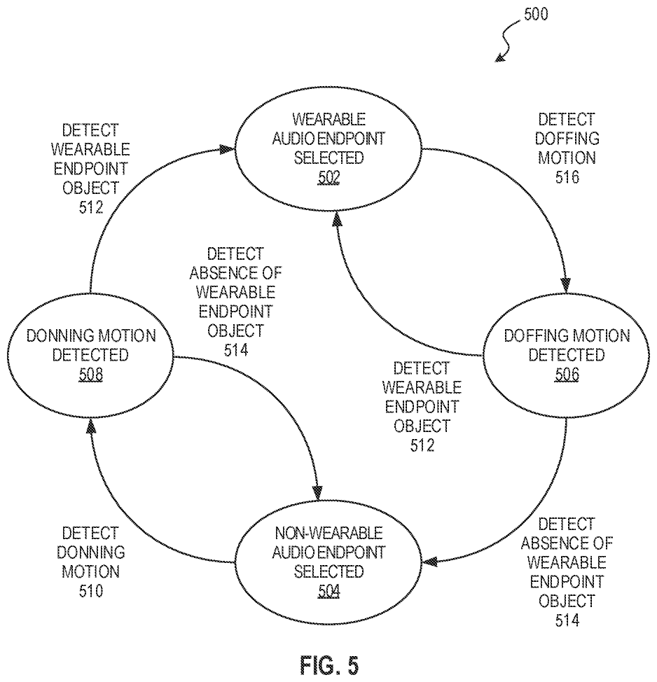

FIG. 5 shows example states 500 of audio endpoints as determined from changes detected by image analysis. The states 500 may be implemented with processor-executable instructions, a machine-learning system, machine-learning models, or a combination of such. Some or all of the states 500 may be implemented by the devices 108, 300 and with the methods 200, 400 discussed above.

State 502 is a state in which a wearable audio endpoint, such as a headset or earbuds, is selected and a non-wearable audio endpoint, such as a computing device's internal or external speaker is not selected.

State 504 is a state in which the non-wearable audio endpoint is selected and the wearable audio endpoint is not selected.

State 506 is a transitionary state from state 502 to state 504. At state 506, a doffing motion has been detected while the wearable audio endpoint is selected and the non-wearable audio endpoint is not selected. While in state 506, the wearable audio endpoint remains selected and the non-wearable audio endpoint remains unselected.

State 508 is a transitionary state from state 504 to state 502. At state 508, a donning motion has been detected while the non-wearable audio endpoint is selected and the wearable audio endpoint is not selected. While in state 508, the non-wearable audio endpoint remains selected and the wearable audio endpoint remains unselected.

Transitions among the states 502, 504, 506, 508 are controlled by image analysis.

Detection of a donning motion 510 in a video by a suitable motion-detecting machine-learning model causes a change from state 504 to state 508, that is, the donning motion detected state 508 is achieved without changing the audio endpoint.

While in state 508, if a representation of a wearable audio endpoint is detected 512 as present in the video by a suitable object-detecting machine-learning model, then state 502 is entered, which completes the transition from state 504 to state 502 to switch from the non-wearable audio endpoint to the wearable audio endpoint. If a representation of a wearable audio endpoint is detected as absent 514, then state 504 is entered to cancel the switch in audio endpoint.

Detection of a doffing motion 516 in a video by a suitable motion-detecting machine-learning model causes a change from state 502 to state 506. The doffing motion detected state 506 is achieved without changing the audio endpoint.

While in state 506, if a representation of a wearable audio endpoint is detected 512 as present in the video by a suitable object-detecting machine-learning model, then state 502 is entered, which cancels the change from wearable audio endpoint to the non-wearable audio endpoint. If a representation of a wearable audio endpoint is detected as absent 514, then state 504 is entered to complete the change from the wearable audio endpoint to the non-wearable audio endpoint.

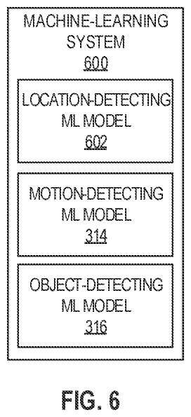

FIG. 6 shows an example machine-learning system 600 that includes location-detecting, motion-detecting, and object-detecting machine-learning models. The machine learning system 600 may be used with the devices 108, 300 discussed above.

The machine learning system 600 includes a motion-detecting machine-learning model 314 and an object-detecting machine-learning model 316, as discussed above.

The machine learning system 600 further includes a location-detecting machine-learning model 602. The location-detecting machine-learning model 602 may include a CNN or similar model that analyzes a static component (e.g., a background) of images captured by a computing device, such as frames of a video captured during a videoconference. The location-detecting machine-learning model 602 may be used to determine whether a location of the computing device that carries the machine-learning system has changed. For example, a user may prefer to use a speaker when participating in a videoconference at home or office workstation and may prefer to use a headset when participating in a videoconference at a public location. Hence, a preferred audio endpoint may depend on whether the user's computing device has changed location.

The location-detecting machine-learning model 602 may apply computer vision to register different locations that may be correlated to preferred audio endpoint selections. A table of correlations between location and preferred audio endpoint may be maintained, so that a default audio endpoint may be selected in response to a detected change in location. Alternatively, the location-detecting machine-learning model 602 may apply computer vision to detect a change from a most recently determined location.

The machine learning system 600 may determine whether a location has changed using the location-detecting machine-learning model 602. That is, the system 600 may determine whether the computing device has changed location since the most recent usage of the selected audio endpoint. If the location has not changed, then the motion-detecting machine-learning model 314 and the object-detecting machine-learning model 316 may be operated at an extended interval or may be disabled on the premise that the presently selected audio endpoint remains preferred for the unchanged location. If the location has changed, then the motion-detecting machine-learning model 314 and the object-detecting machine-learning model 316 may be operated at a reduced interval to quickly determine whether another audio endpoint is preferred at the new location.

In terms of the methods 200, 400 discussed above, detection of a change in location may control the frequency at which the method 200, 400 is repeated. A changed location may increase a frequency of performance of the method 200, 400. An unchanged location may reduce the frequency of performance of the method 200, 400 or prevent the method 200, 400 from being executed.

In other examples, various combinations of one or more of a location-detecting machine-learning model 602, a motion-detecting machine-learning model 314, and an object-detecting machine-learning model 316 may be used.

In view of the above, it should be apparent that image analysis may be used to automatically switch audio endpoints to provide convenience and efficiency. Machine learning may be used to perform the image analysis. Further, different types of image analyses, such as motion detection, object detection, and location detection, may be combined, for example, in stages.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a processor, cause the processor to:
analyze a video captured by a computing device to detect a sequence of motion in the video; and
select an audio endpoint of the computing device based on the sequence of motion.

2. The non-transitory machine-readable medium of claim 1, wherein:
the audio endpoint is a first audio endpoint; and
based on the sequence of motion, the instructions are further to deselect a second audio endpoint.

3. The non-transitory machine-readable medium of claim 1, wherein the instructions are further to:
analyze the video to detect a representation of the audio endpoint in the video; and
select the audio endpoint further based on detection of the representation of the audio endpoint.

4. The non-transitory machine-readable medium of claim 1, wherein the instructions are further to:
classify the sequence of motion as a donning gesture; and
select the audio endpoint based on the donning gesture.

5. The non-transitory machine-readable medium of claim 1, wherein the instructions are further to:
classify the sequence of motion as a doffing gesture; and
select the audio endpoint based on the doffing gesture.

6. A non-transitory machine-readable medium comprising instructions that, when executed by a processor, cause the processor to:
apply images captured by a computing device to a trained machine-learning system;
detect with the trained machine-learning system a visual indication of a engagement of an audio endpoint;
in response to detection of the visual indication, detect with the trained machine-learning system a representation of the audio endpoint; and
in response to detection of the representation of the audio endpoint, automatically switch audio endpoints of the computing device.

7. The non-transitory machine-readable medium of claim 6, wherein:
the visual indication includes a donning gesture;
the representation of the audio endpoint includes a wearable audio endpoint; and
the instructions are further to, in response to detection of the representation of the audio endpoint, switch from a speaker to the wearable audio endpoint.

8. The non-transitory machine-readable medium of claim 6, wherein:
the visual indication includes a doffing gesture;
the representation of the audio endpoint includes an absence of a wearable audio endpoint; and
the instructions are further to, in response to detection of the representation of the audio endpoint, switch from the wearable audio endpoint to a speaker.

9. The non-transitory machine-readable medium of claim 6, wherein the trained machine-learning system includes:
a motion-detecting model trained to detect visual indications of user gestures; and
an object-detecting model trained to detect visual representations of audio endpoints.

10. The non-transitory machine-readable medium of claim 6, wherein the instructions are to apply the images, detect the visual indication of the engagement of the audio endpoint, detect the representation of the audio endpoint, and automatically switch audio endpoints in real time or near real time during a videoconference.

11. A computing device comprising:
a camera;
a speaker;
a machine-learning system; and
a processor connected to the camera and the speaker, the processor further connectable to a wearable audio endpoint, the processor to:
apply the machine-learning system to perform image analysis on images captured by the camera; and
switch between the speaker and the wearable audio endpoint based on the image analysis.

12. The computing device of claim 11, wherein the machine-learning system includes a machine-learning model to detect hand motion indicative of a user putting on or removing the wearable audio endpoint.

13. The computing device of claim 11, wherein the machine-learning system includes a machine-learning model to detect representations of headsets and earbuds in the images.

14. The computing device of claim 11, wherein the machine-learning system includes a machine-learning model to detect a change in location of the computing device.

15. The computing device of claim 11, wherein the processor is to:
apply the machine-learning system to perform image analysis to detect a hand motion; and
in response to detection of the hand motion, apply the machine-learning system to perform additional image analysis to detect the wearable audio endpoint; and
switch between the speaker and the wearable audio endpoint in response to detection of the wearable audio endpoint.
